(19) United States
(12) Patent Application Publication
(10) Pub. No.: US 2026/0362298 A1
(43) Pub. Date: Nov. 12, 2026

(54) Opportunistic WLAN Passive Scan Optimization

(71) Applicant: Silicon Laboratories Inc., Austin, TX (US)

(72) Inventors: Ram Krishna Poricha, Hyderabad (IN); Krishna Babu Pedda, West Godavari (IN); Atul Suresh Joshi, Pune (IN); Narasimha Rao Anumolu, Hyderabad (IN)

(21) Appl. No.: 19/199,651

(22) Filed: May 6, 2025

(51) Int. Cl. H04W 48/16; H04B 17/318

(52) U.S. Cl. CPC H04W 48/16; H04B 17/318

(57) ABSTRACT

A Wi-Fi network device that opportunistically reduces the passive scanning duration is disclosed. The Wi-Fi network device monitors all frames transmitted over the Wi-Fi network during the scanning duration. If a probe request is detected, the Wi-Fi network device may reduce the length of its scanning duration if one or more conditions are met. Additionally, the Wi-Fi network device processes probe responses that are not directed at it to obtain more information about access points that are available in the service area. The Wi-Fi network device may use this information to select an optimal access point to associate with.

### FIELD

This disclosure describes a system and various methods to reduce power consumption and scanning duration for devices performing passive scans to identify access points in a Wi-Fi network.

### BACKGROUND

The Wi-Fi protocol was originally designed mostly for devices which have access to unlimited power. Thus, early revisions of the specification did not include many provisions to support low power devices, which need to enter low power modes in order to conserve battery life. For example, some devices, such as sensor devices, should ideally have a battery life that is more than one year.

The Wi-Fi protocol identifies two different mechanisms to determine the presence of access points in an area. The first mechanism, which is shown in FIG. 1, is referred to as passive scan. In this embodiment, the Wi-Fi network device is in a low power mode most of the time. The Wi-Fi network device exits the low power mode and enters a scanning mode for a period referred to as a passive scan duration. During this passive scan duration, the Wi-Fi network device listens for frames transmitted from access points, which as known as beacons. These access points transmit a beacon once per beacon interval. In this figure, a second access point, AP2, transmits a beacon 2 every beacon interval. Similarly, a third access point, AP3, transmits a beacon 3 every beacon interval. Thus, to ensure that the Wi-Fi network device is able to listen to as many beacons as possible, the passive scan duration is typically set to a value that is greater than the beacon interval used by most access points. However, a first access point, AP1, uses a longer beacon interval. Thus, the first access point is transmitting a beacon 1 at half the frequency of the other access points. Therefore, if the passive scan duration is set to a value that is only slightly greater than the beacon interval used by most access points, there is a possibility that the Wi-Fi network device will not be passively scanning when the beacon 1 from AP1 is transmitted.

A second mechanism, referred to as active scan, is shown in FIG. 2. In this mechanism, the Wi-Fi network device exits low power mode and enters a scanning mode. In this scanning mode, the Wi-Fi network device transmits a probe request 4 using a wildcard SSID such that all access points that receive the probe request respond. In response to the probe request 4, AP1 transmits a probe response 5, AP2 transmits a probe response 6 and AP3 transmits a probe response 7. Note that since all of the access points respond to the probe request 4, the amount of time that the Wi-Fi network device is in listening mode may be significantly reduced. For example, the active scan duration may be 30 milliseconds, wherein the passive scan duration may be 100 milliseconds or more.

Further, the active scan may be more robust, as all access points respond to the Wi-Fi network device during the active scan duration. In contrast, it is possible that, in passive scan mode, that the Wi-Fi network device may not receive one or more beacons, depending on the passive scan duration and the beacon interval used by each of the access points.

Although the Wi-Fi network device spends less time in scanning mode using the active scan mechanism, the power consumed by the transmission of the probe request is significant and may be more than the power saved because of the shorter scan duration.

Therefore, it would be beneficial if there were a system and method by which a Wi-Fi network device may receive more beacons, thus obtaining more scan results, while remaining in passive scanning mode for a shorter period of time. Further, it would be advantageous if this system and method did not require any modifications to the access points.

### SUMMARY

A Wi-Fi network device that opportunistically reduces the passive scanning duration is disclosed. The Wi-Fi network device monitors all frames transmitted over the Wi-Fi network during the scanning duration. If a probe request is detected, the Wi-Fi network device may reduce the length of its scanning duration if one or more conditions are met. Additionally, the Wi-Fi network device processes probe responses that are not directed at it to obtain more information about access points that are available in the service area. The Wi-Fi network device may use this information to select an optimal access point to associate with.

According to one embodiment, a method of operating a Wi-Fi network device during a passive scanning procedure is disclosed. The method comprises initializing a timer of the Wi-Fi network device to a first value, wherein the timer is used to determine a length of a scanning duration; passively scanning to listen for frames being transmitted on a Wi-Fi network during the scanning duration; and updating the timer to a second value, less than the first value, if a probe request transmitted by a second Wi-Fi network device is detected and one or more conditions are satisfied. In some embodiments, the one or more conditions comprises a Received Signal Strength Indicator(RSSI) associated with the probe request being greater than a predetermined threshold. In some embodiments, the one or more conditions comprises a Service Set Identifier (SSID) that includes a wildcard value. In some embodiments, the one or more conditions comprises a remaining timer value that exceeds the second value. In some embodiments, the method comprises receiving and processing probe responses at the Wi-Fi network device that are directed to the second Wi-Fi network device and are transmitted in response to the probe request to obtain information about available access points. In certain embodiments, the method comprises associating the Wi-Fi network device with an access point based on the information obtained from the probe responses. In some embodiments, a probe request is not detected, and the method comprises receiving and processing probe responses at the Wi-Fi network device that are directed to another Wi-Fi network device to obtain information about available access points. In certain embodiments, the method comprises associating the Wi-Fi network device with an access point based on the information obtained from the probe responses.

According to another embodiment, a Wi-Fi network device is disclosed. The Wi-Fi network device comprises a Wi-Fi network interface; a processing unit; and a memory device in communication with the processing unit comprising instructions, which when executed by the processing unit, enable the Wi-Fi network device to: initialize a timer to a first value, wherein the timer is used to determine a length of a scanning duration; passively scan for frames transmitted over a Wi-Fi network; and update the timer to a second value if a probe request transmitted from a second Wi-Fi network device is detected and one or more conditions are satisfied. In some embodiments, the one or more conditions comprises a Received Signal Strength Indicator(RSSI) associated with the probe request being greater than a predetermined threshold. In some embodiments, the one or more conditions comprises a Service Set Identifier (SSID) that includes a wildcard value. In some embodiments, the one or more conditions comprises a remaining timer value that exceeds the second value. In some embodiments, the Wi-Fi network device receives and processes probe responses that are directed to the second Wi-Fi network device and are transmitted in response to the probe request to obtain information about available access points. In certain embodiments, the Wi-Fi network device associates with an access point based on the information obtained from the probe responses. In some embodiments, a probe request is not detected by the Wi-Fi network device, and the Wi-Fi network device receives and processes probe responses that are directed to another Wi-Fi network device to obtain information about available access points. In certain embodiments, the Wi-Fi network device associates with an access point based on the information obtained from the probe responses.

According to another embodiment, a method of operating a Wi-Fi network device during a passive scanning procedure is disclosed. The method comprises passively scanning to listen for beacons being transmitted by access points on a Wi-Fi network during a passive scanning duration; passively listening for probe responses being transmitted by the access points on the Wi-Fi network during the passive scanning duration, wherein the probe responses are directed toward a different Wi-Fi network device; processing the beacons and the probe responses to obtain information about available access points; and associating the Wi-Fi network device with an access point based on the information about available access points obtained from the beacons and the probe responses.

In some embodiments, the Wi-Fi network device does not transmit any probe requests during the passive scanning duration. In some embodiments, the method comprises passively listening for and processing probe requests being transmitted by other Wi-Fi network devices on the Wi-Fi network during the passive scanning duration. In certain embodiments, the method comprises adjusting a length of the passive scanning duration if a probe request is received and one or more conditions are satisfied.

### BRIEF DESCRIPTION OF THE DRAWINGS

For a better understanding of the present disclosure, reference is made to the accompanying drawings, in which like elements are referenced with like numerals, and in which:

FIG. 1 shows a timing diagram showing a Wi-Fi network device and multiple access points during a passive scan;

FIG. 2 shows a timing diagram showing a Wi-Fi network device and multiple access points during an active scan;

FIG. 3 shows a block diagram of a Wi-Fi network device;

FIG. 4 shows a Wi-Fi network with multiple access points, active scanning devices and Wi-Fi network devices;

FIGS. 5-7 shows the operation of the Wi-Fi network device under different scenarios;

FIG. 8A-8C shows the topology of a Wi-Fi network having a plurality of active scanning devices and access points; and

FIG. 9 shows a flowchart that may be used to determine whether the timer value should be updated.

### DETAILED DESCRIPTION

This disclosure presents a system and method that describes techniques to reduce power consumption and scanning duration when a Wi-Fi network device is passively scanning for access points in a Wi-Fi network.

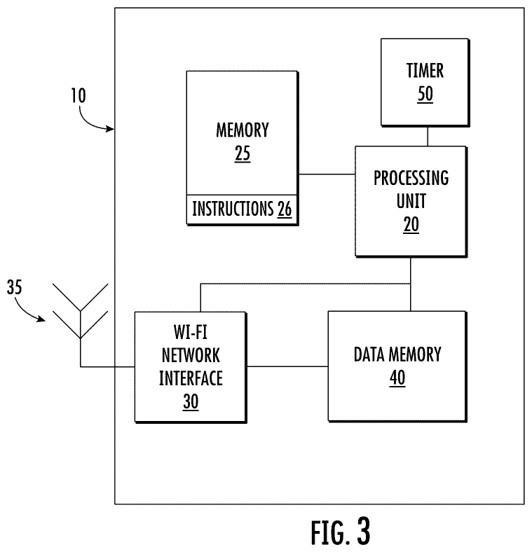

FIG. 3 shows a block diagram of a representative Wi-Fi network device 10 that may be used to implement the disclosed method of minimizing power consumption in a Wi-Fi network device.

The Wi-Fi network device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the Wi-Fi network device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 3. The second computer readable non-transitory media may be a CDROM, or a different memory device, which is located remote from the Wi-Fi network device 10. The instructions contained on this second computer readable non-transitory media may be downloaded onto the memory device 25 to allow execution of the instructions by the Wi-Fi network device 10.

The Wi-Fi network device 10 also includes a Wi-Fi network interface 30 that connects with a Wi-Fi network using an antenna 35.

The Wi-Fi network device 10 may include a data memory device 40 in which data that is received and transmitted by the Wi-Fi network interface 30 is stored. This data memory device 40 is traditionally a volatile memory. The processing unit 20 has the ability to read and write the data memory device 40 so as to communicate with the other devices in the Wi-Fi network.

The Wi-Fi network device 10 may operate in one of several modes. In normal operating mode, all of the components may be powered on and completely functional. In a low power mode, components within the Wi-Fi network device 10 are powered off or placed in a low power state. For example, the Wi-Fi network interface 30 may be powered down so it is unable to receive or transmit on the Wi-Fi network. Additionally, the processing unit 20 may be powered off or enter a low power mode.

The Wi-Fi network device 10 may also include a timer 50. This timer may be used to allow the processing unit 20 to exit low power mode. Although not shown, the Wi-Fi network device 10 also has a power supply, which may be a battery.

While the processing unit 20, the memory device 25, the Wi-Fi network interface 30, the timer 50 and the data memory device 40 are shown in FIG. 3 as separate components, it is understood that some or all of these components may be integrated into a single electronic component. Rather, FIG. 3 is used to illustrate the functionality of the Wi-Fi network device 10, not its physical configuration.

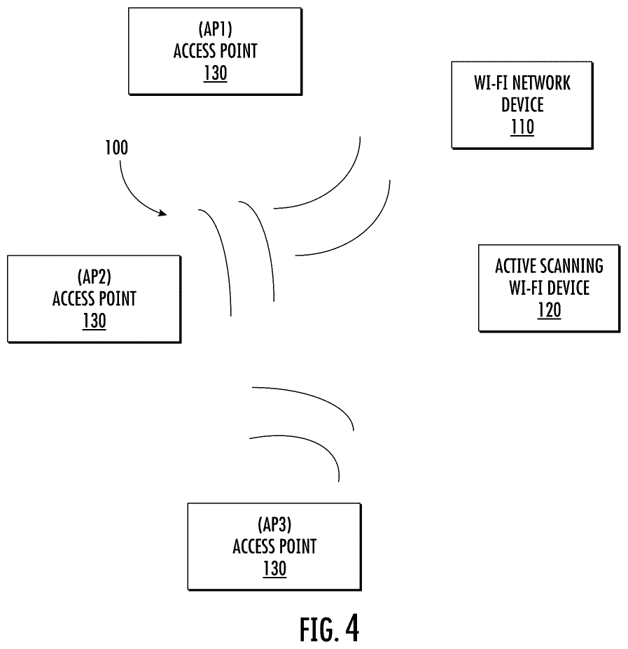

FIG. 4 shows a Wi-Fi network 100 that includes a Wi-Fi network device 110, at least one active scanning Wi-Fi device 120 and a plurality of access points 130. In this figure, there are three access points 130, which are labelled as AP1, AP2 and AP3. The Wi-Fi network device 110 has the architecture shown in FIG. 3. The active scanning Wi-Fi device 120 may have a similar architecture to that shown in FIG. 3, but may have a larger battery or a permanent power connection. The access points 130 may also have a similar architecture as is shown in FIG. 3, but may have a large powerful processing unit and large memory devices.

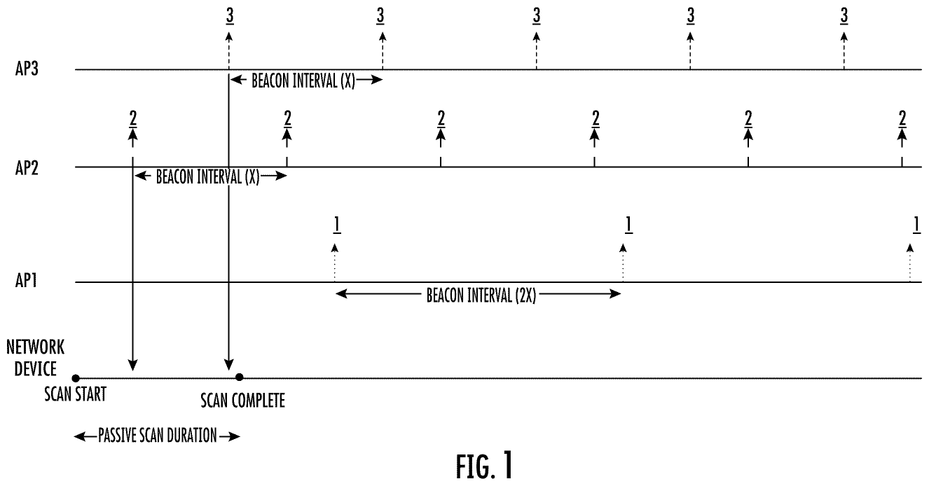

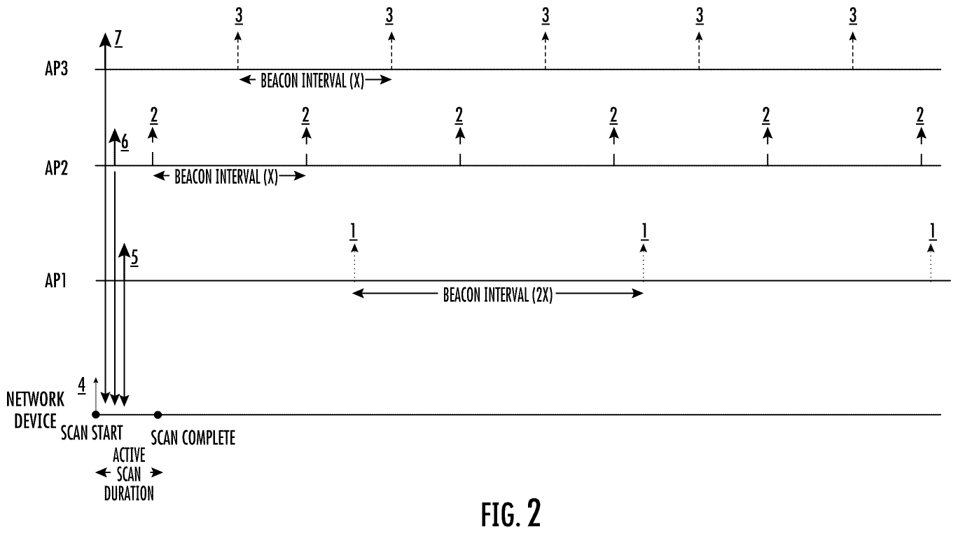

During initialization, the Wi-Fi network device 110 attempts to connect to one of the plurality of access points 130. In some embodiments, the Wi-Fi network device 110 may select the optimal access point based on its proximity to each access point, which is typically determined using Received Signal Strength Indicator (RSSI). In other embodiments, the Wi-Fi network device 110 may select the access point based on the features or performance of the access point. In order to make this determination, the Wi-Fi network device 110 needs to identify all or most of the access points in the local area. This is traditionally done using passive scanning, as shown in FIG. 1, or active scanning, as shown in FIG. 2.

However, the Wi-Fi network device 110 of the present disclosure uses a more sophisticated approach. The Wi-Fi network device 110 operates in passive scanning mode. In other words, the Wi-Fi network device 110 will not transmit any probe requests and will set its scanning duration to a value that is greater than the beacon interval used by most of the access points. However, additionally, the Wi-Fi network device 110 implements one or more enhancements.

The first enhancement, which is not typically performed in passive scanning, is to listen and process any probe responses that take place during the scan period. This enhancement helps provide a more robust scan result for the Wi-Fi network device 110. For example, if another Wi-Fi device, such as active scanning Wi-Fi device 120, performs an active scan, there will be probe responses from all access points that received the probe request. Thus, during passive scan mode, the Wi-Fi network device 110 listens for frames that are transmitted and processes these frames, looking specifically for probe responses.

The second enhancement is to modify the scanning duration based on the observed frames that are transmitted on the Wi-Fi network 100. In this embodiment, the Wi-Fi network device 110 listens for frames during the passive scanning duration for probe requests. If a probe request is received, the Wi-Fi network device 110 is aware that another Wi-Fi device, such as active scanning Wi-Fi device 120, is performing an active scan. Therefore, access points 130 may be transmitting probe responses shortly. In response, the Wi-Fi network device 110 may change its scanning duration to a shorter value, such as the scanning duration typically used for active scans. In some embodiments, the Wi-Fi network device only modifies the scanning duration if the probe request was transmitted with a wildcard SSID.

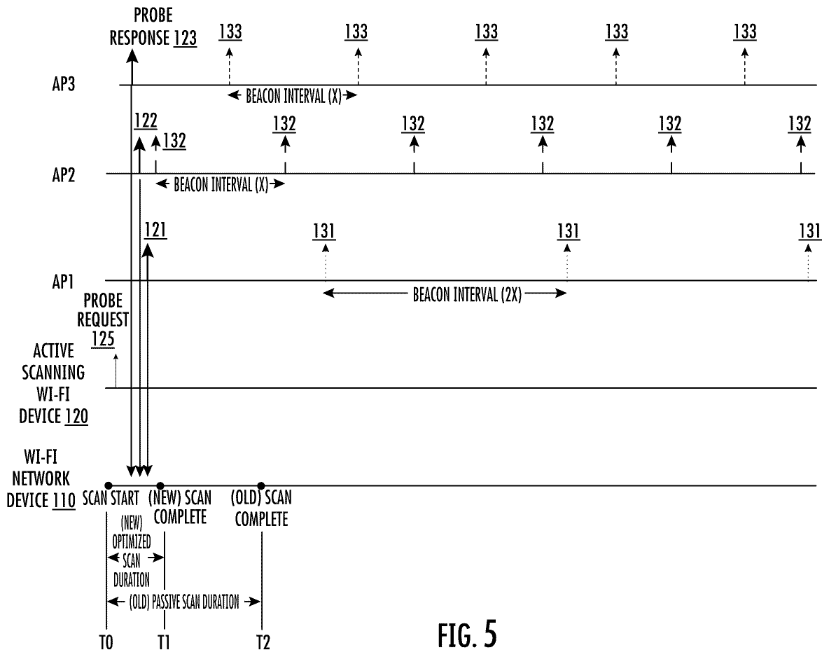

FIGS. 5-7 show timing diagrams that include one or more of these enhancements. These figures include access points 130, such as AP1, AP2 and AP3. These access points 130 transmit beacons at regular intervals. As explained above, AP2 transmits beacons 132 every beacon interval, and AP3 also transmits beacons 133 every beacon interval. AP1 also transmits beacons 131 every beacon interval, but uses a beacon interval that is twice as long as that used for AP2 and AP3. In FIG. 5, the Wi-Fi network device 110 starts its scanning period at time T0 and begins listening for frames transmitted on the Wi-Fi network 100. Soon thereafter, the active scanning Wi-Fi device 120 transmits a probe request 125. In response, the access points 130 respond with probe responses. Specifically, AP1 transmits probe response 121, AP2 transmits probe response 122 and AP3 transmits probe response 123. As expected, the active scanning Wi-Fi device 120 terminates its scanning duration shortly thereafter.

In this embodiment, the Wi-Fi network device 110, which did not issue the probe request 125, receives this probe request 125. Knowing that the access points 130 will all respond to the probe request 125 shortly, the Wi-Fi network device 110 changes its scanning duration from the first value which is used for passive scanning, to a second value, which is shorter than the first value and may be the same as the duration used by actively scanning devices. This may be achieved by writing the second value into the timer 50. Following expiration of this shorter scanning duration, which occurs at time T1, the Wi-Fi network device 110 exits scanning mode. Note that while in scanning mode, the Wi-Fi network device 110 captures and processes the contents of each probe response to obtain information about the access points 130. Note that time T1 is much sooner than time T2, which is when the scanning duration would have expired if the behavior of the Wi-Fi network device 110 was not modified. Also note that, AP1 sends its beacons 131 at a lower rate than the other access points, since it uses a beacon interval that is longer than the other access points. Therefore, even if the Wi-Fi network device 110 had continued scanning until time T2, it still would not have received a beacon 131 from AP1. By also capturing and processing probe responses that are not intended for this device, the Wi-Fi network device 110 is able to gain information that it may not have gotten otherwise. Note that in this figure, the probe request 125 came shortly after time T0, so the scanning duration of the Wi-Fi network device 110 is made very short. Of course, the probe request 125 may be sent at other times.

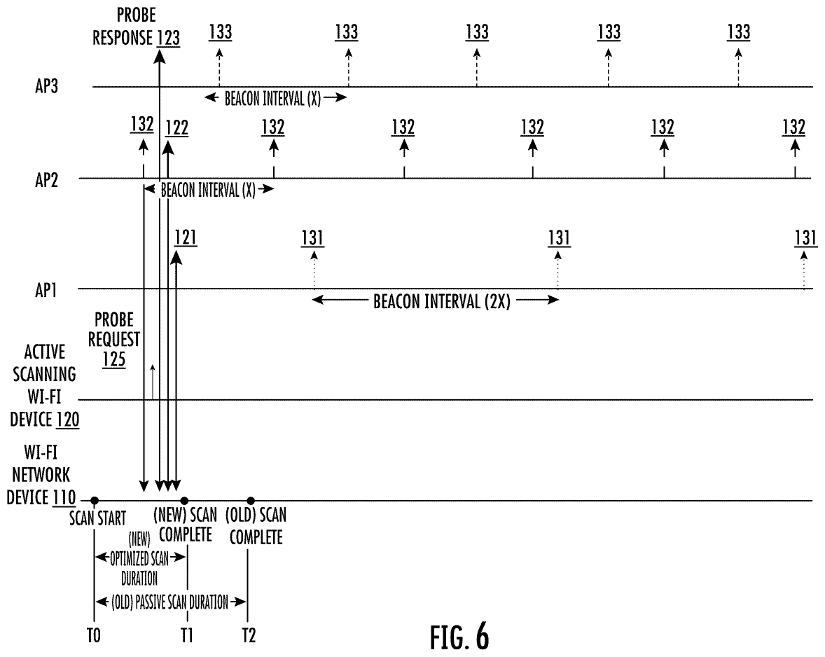

FIG. 6 shows another scenario similar to that shown in FIG. 5. However, in this scenario, the probe request comes much later than time T0. As described above, the Wi-Fi network device 110 detects and processes the probe request 125. In response, the Wi-Fi network device 110 may change its scanning duration. Specifically, when a probe request 125 is detected, the second value may be written to the timer 50. However, if the current value of the timer 50 is less than the second value, the Wi-Fi network device 110 may not change its timer value. Thus, in some embodiments, the Wi-Fi network device 110 updates its timer 50 whenever a probe request 125 is detected. However, in other embodiments, the timer 50 may only be updated if the current value of the timer 50 is greater than the second value. In other words, in some embodiments, the scanning duration never extends beyond time T2. However, in other embodiments, the scanning period may extend beyond time T2. As an example, assume that the first value, which is associated with the normal passive scanning duration, is 100 milliseconds and the second value, which is associated with the active scanning duration, is 30 milliseconds. In some embodiments, the Wi-Fi network device 110 only updates the timer 50 if the probe request 125 occur less than 70 milliseconds after time T0. Note that while in scanning mode, the Wi-Fi network device 110 captures and processes the contents of each probe response to obtain information about the access points 130.

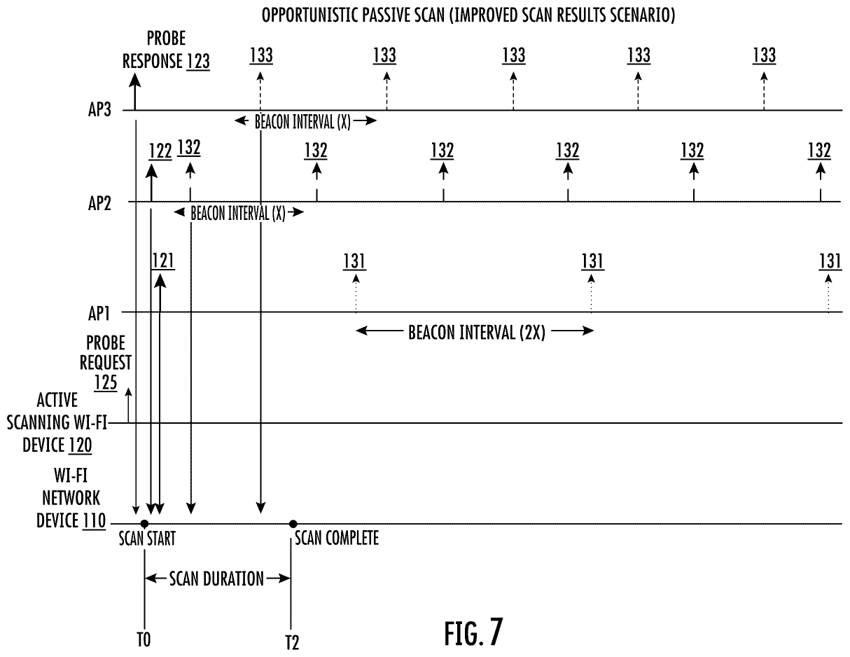

Thus, FIGS. 5-6 show two scenarios where the Wi-Fi network device 110 changes its scanning duration and also processes incoming probe responses than are not directed to it. However, it is also possible that the Wi-Fi network device 110 processes incoming probe responses without changing its scanning duration. FIG. 7 shows another scenario wherein the probe request 125 occurred prior to the start of the scanning period for the Wi-Fi network device 110 (i.e. before time T0). Because the probe request 125 was not seen by the Wi-Fi network device 110, the Wi-Fi network device 110 does not change its scanning duration. Thus, the scanning duration extends from time T0 to time T2. However, during this scanning duration, the Wi-Fi network device 110 captures and processes the probe responses that are transmitted by the access points 130. In this way, even though AP1 did not send a beacon 131 during the scanning duration, the Wi-Fi network device 110 is still aware of its existence because it received the probe response 121.

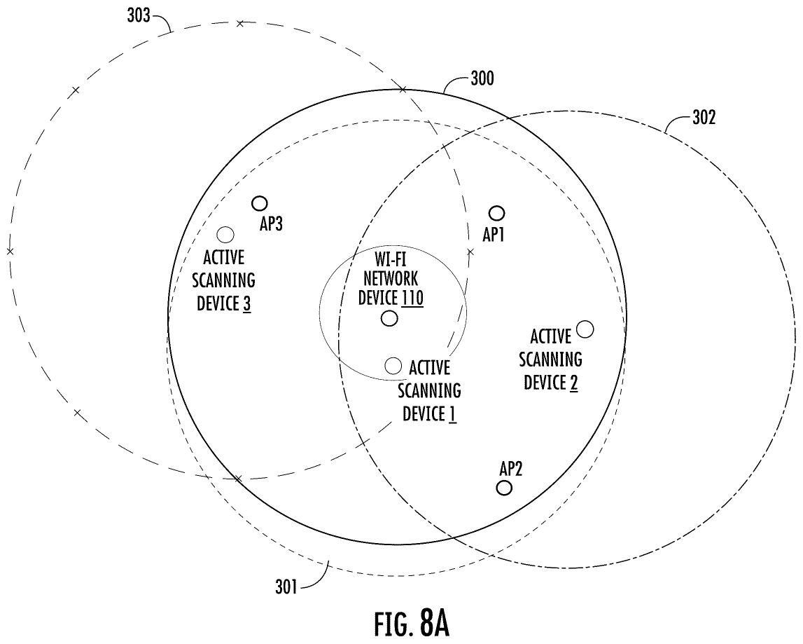

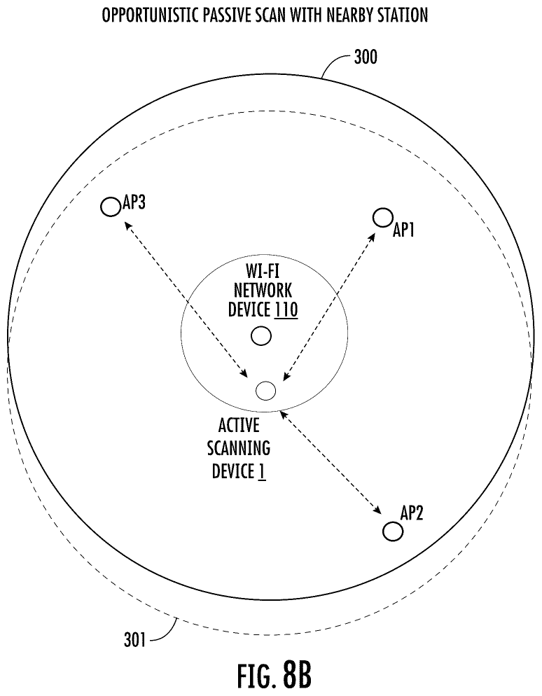

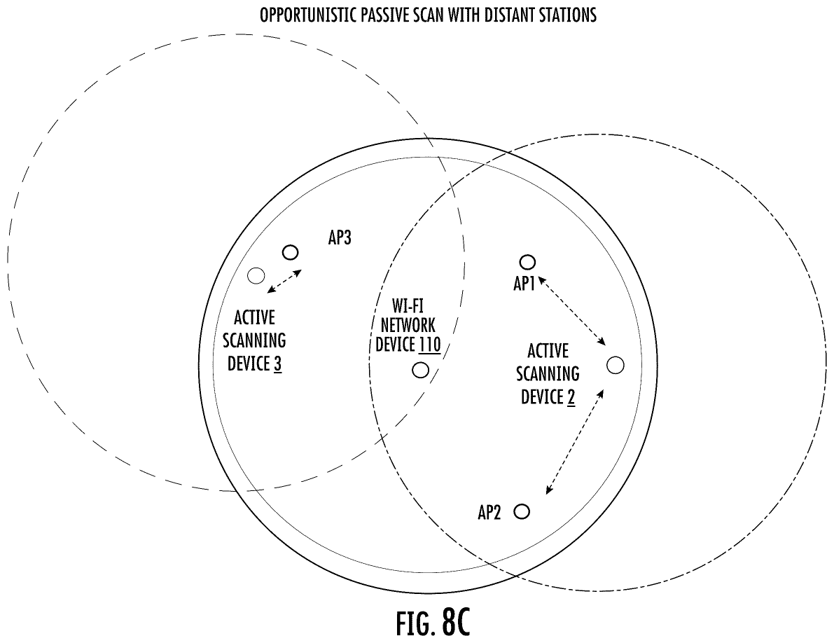

Note that the scenarios shown in FIGS. 5-7 assume that probe responses are returned from every access point 130 that is accessible by the Wi-Fi network device 110. However, this may not always be true. FIG. 8A shows an example topology of a Wi-Fi network. In this topology, there are three access points 130 (labelled AP1, AP2 and AP3). Additionally, there are three active scanning Wi-Fi devices 120 (labelled Active Scanning Device 1, Active Scanning Device 2, Active Scanning Device 3). The transmission and listening range of Active Scanning Device 1 is shown by circle 301. Similarly, the transmission and listening range of Active Scanning Device 2 is shown by circle 302 and the transmission and listening range of Active Scanning Device 3 is shown by circle 303. Thus, when Active Scanning Device 3 transmits a probe request, it is detected by AP3, but not by AP1 and AP2. Similarly, when Active Scanning Device 2 transmits a probe request, it is detected by AP1 and AP2, but not by AP3. However, note that all of these access points are within the listening range 300 of the Wi-Fi network device 110.

Thus, as shown in FIG. 8B, when Active Scanning Device 1 transmits a probe request, all of the access points 130 that are in the listening range 300 of the Wi-Fi network device 110 will respond. However, as shown in FIG. 8C, when either of other two active scanning devices transmit a probe request, all of the access points 130 will not respond. Thus, in certain embodiments, the Wi-Fi network device 110 may use the RSSI of the probe request 125 to determine whether it should update its timer 50. In these embodiments, if the RSSI is greater than a predetermined threshold, the Wi-Fi network device 110 will update its timer 50. However, if the RSSI of the probe request 125 is less than the predetermined threshold, the timer 50 will not be modified, but the probe responses will still be processed.

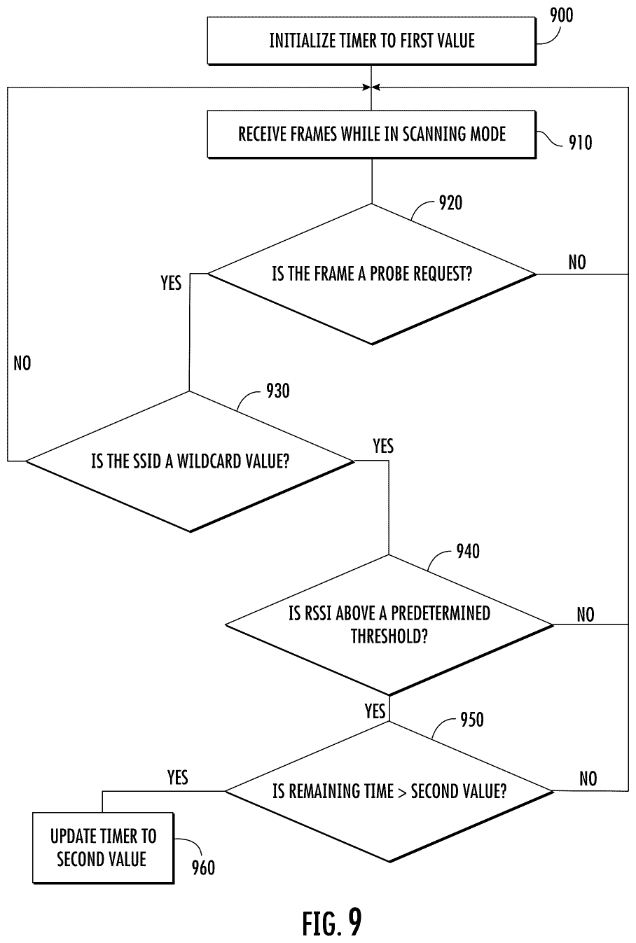

FIG. 9 shows a flowchart explaining the operation of the Wi-Fi network device 110 with respect to the scanning duration. As described above, and shown in Box 900, the timer 50 is initially set to the first value, which may be the typical duration used for passive scanning. This first value may be 100 milliseconds or more. The Wi-Fi network device 110 begins scanning, as shown in Box 910. While scanning, it checks if it receives a probe request 125, as shown in Decision Box 920. If the frame is not a probe request, the timer 50 will not be changed, the Wi-Fi network device 110 continues looking for probe requests. However, if a probe request is received, the Wi-Fi network device 110 optionally checks to ensure that the Service Set Identifier (SSID) in this probe request includes a wildcard value, as shown in Decision Box 930. The use of wildcard SSID ensures that all access points 130 will respond. If so, the Wi-Fi network device 110 optionally checks the RSSI of the probe request 125, as shown in Decision Box 940. If the RSSI is not greater than a predetermined threshold, the Wi-Fi network device 110 returns to search for another probe request. If the RSSI is greater than the predetermined threshold, the Wi-Fi network device 110 may check to see how much time is left in the scanning duration, as shown in Decision Box 950. If the remaining time is greater than the second value, then the Wi-Fi network device 110 loads the second value into the timer 50, as shown in Box 960. Note that one or more of these checks may not be performed. If a check is not performed, the Wi-Fi network device 110 proceeds through this flowchart as though the result of the check was a “YES”.

This system and method has many advantages. First, in certain embodiments, the Wi-Fi network device 110 is able to reduce its scanning duration without sacrificing scan results if it detects a probe request.

In addition to potentially reducing the scanning duration, the method and system described herein may result in an improved scan result. When the Wi-Fi network device 110 is initialized, it scans the various channels of the Wi-Fi network for the optimal access point to associate with. In some embodiments, the optimal access point may be the access point that is closest, as detected using RSSI. In other embodiments, the optimal access point may be one that has a certain set of desired features, such as high bandwidth. By capturing the probe responses, the Wi-Fi network device 110 may learn information about access points that it would not otherwise learn. For example, referring to FIG. 7, if the Wi-Fi network device 110 does not process the probe responses, it would not be able to determine that AP1 was present, since there were no beacons 131 from AP1 during the scanning duration from time T0 to time T2. Thus, even if the scanning duration is not reduced, the scan results may be improved.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of operating a Wi-Fi network device during a passive scanning procedure, comprising:
initializing a timer of the Wi-Fi network device to a first value, wherein the timer is used to determine a length of a scanning duration;
passively scanning to listen for frames being transmitted on a Wi-Fi network during the scanning duration; and
updating the timer to a second value, less than the first value, if a probe request transmitted by a second Wi-Fi network device is detected and one or more conditions are satisfied.

2. The method of claim 1, wherein the one or more conditions comprises a Received Signal Strength Indicator(RSSI) associated with the probe request being greater than a predetermined threshold.

3. The method of claim 1, wherein the one or more conditions comprises a Service Set Identifier (SSID) that includes a wildcard value.

4. The method of claim 1, wherein the one or more conditions comprises a remaining timer value that exceeds the second value.

5. The method of claim 1, further comprising receiving and processing probe responses at the Wi-Fi network device that are directed to the second Wi-Fi network device and are transmitted in response to the probe request to obtain information about available access points.

6. The method of claim 5, further comprising associating the Wi-Fi network device with an access point based on the information obtained from the probe responses.

7. The method of claim 1, wherein a probe request is not detected, and further comprising receiving and processing probe responses at the Wi-Fi network device that are directed to another Wi-Fi network device to obtain information about available access points.

8. The method of claim 7, further comprising associating the Wi-Fi network device with an access point based on the information obtained from the probe responses.

9. A Wi-Fi network device, comprising:
a Wi-Fi network interface;
a processing unit; and
a memory device in communication with the processing unit comprising instructions, which when executed by the processing unit, enable the Wi-Fi network device to:
initialize a timer to a first value, wherein the timer is used to determine a length of a scanning duration;
passively scan for frames transmitted over a Wi-Fi network; and
update the timer to a second value if a probe request transmitted from a second Wi-Fi network device is detected and one or more conditions are satisfied.

10. The Wi-Fi network device of claim 9, wherein the one or more conditions comprises a Received Signal Strength Indicator(RSSI) associated with the probe request being greater than a predetermined threshold.

11. The Wi-Fi network device of claim 9, wherein the one or more conditions comprises a Service Set Identifier (SSID) that includes a wildcard value.

12. The Wi-Fi network device of claim 9, wherein the one or more conditions comprises a remaining timer value that exceeds the second value.

13. The Wi-Fi network device of claim 9, wherein the Wi-Fi network device receives and processes probe responses that are directed to the second Wi-Fi network device and are transmitted in response to the probe request to obtain information about available access points.

14. The Wi-Fi network device of claim 13, wherein the Wi-Fi network device associates with an access point based on the information obtained from the probe responses.

15. The Wi-Fi network device of claim 9, wherein a probe request is not detected by the Wi-Fi network device, and wherein the Wi-Fi network device receives and processes probe responses that are directed to another Wi-Fi network device to obtain information about available access points.

16. The Wi-Fi network device of claim 15, wherein the Wi-Fi network device associates with an access point based on the information obtained from the probe responses.

17. A method of operating a Wi-Fi network device during a passive scanning procedure, comprising:
passively scanning to listen for beacons being transmitted by access points on a Wi-Fi network during a passive scanning duration;
passively listening for probe responses being transmitted by the access points on the Wi-Fi network during the passive scanning duration, wherein the probe responses are directed toward a different Wi-Fi network device;
processing the beacons and the probe responses to obtain information about available access points; and
associating the Wi-Fi network device with an access point based on the information about available access points obtained from the beacons and the probe responses.

18. The method of claim 17, wherein the Wi-Fi network device does not transmit any probe requests during the passive scanning duration.

19. The method of claim 17, further comprising passively listening for and processing probe requests being transmitted by other Wi-Fi network devices on the Wi-Fi network during the passive scanning duration.

20. The method of claim 19, further comprising adjusting a length of the passive scanning duration if a probe request is received and one or more conditions are satisfied.
